SEQUENCE LISTING (7 sequences)

SEQ ID NO: 1 - protein, 520 aa, Humicola insolens
  mat_peptide (1)..(194)
MSRFHSLLAFVVASLTAVAHAGIGPVADLTITNAAVSPDGFSRQAVVVNGGTPGPLITGNMGDRFQLNVIDNLTNHTMVKSTSIHWHGFFQKGTNWADGPAFINQCPISSGHSFLYDFQVPDQAGTFWYHSHLSTQYCDGLRGPFVVYDPNDPAADLYDVDNDDTVITLVDWYHVAAKLGPAFPLGADATLINGKGRSPSTTTADLSVISVTPGKRYRFRLVSLSCDPNYTFSIDGHNMTIIETDSINTAPLVVDSIQIFAAQRYSFVLEANQAVDNYWIRANPNFGNVGFTGGINSAILRYDGAAAVEPTTTQTTSTAPLNEVNLHPLVTTAVPGSPVAGGVDLAINMAFNFNGTNFFINGTSFTPPTVPVLLQIISGAQNAQDLLPSGSVYSLPSNADIEISFPATAAAPGAPHPFHLHGHAFAVVRSAGSTVYNYDNPIFRDVVSTGTPAAGDNVTIRFRTDNPGPWFLHCHIDFHLEAGFAVVFAEDIPDVASANPVPQAWSDLCPTYDALDPSDQ

SEQ ID NO: 2 - protein, 199 aa, Fusarium solani pisi
  mat_peptide (1)..(199)
GRTTRDDLINGNSASCADVIFIYARGSTETGNLGTLGPSIASNLESAFGKDGVWIQGVGGAYRATLGDNALPRGTSSAAIREMLGLFQQANTKCPDATLIAGGYSQGAALAAASIEDLDSAIRDKIAGTVLFGYTKNLQNRGRIPNYPADRTKVFCNTGDLVCTGSLIVAAPHLAYGPDARGPAPEFLIEKVRAVRGSA

SEQ ID NO: 3 - protein, 620 aa, Myceliophthora thermophila
MKSFISAATLLVGILTPSVAAAPPSTPEQRDLLVPITEREEAAVKARQQSCNTPSNRACWTDGYDINTDYEVDSPDTGVVRPYTLTLTEVDNWTGPDGVVKEKVMLVNNSIIGPTIFADWGDTIQVTVINNLETNGTSIHWHGLHQKGTNLHDGANGITECPIPPKGGRKVYRFKAQQYGTSWYHSHFSAQYGNGVVGAIQINGPASLPYDTDLGVFPISDYYYSSADELVELTKNSGAPFSDNVLFNGTAKHPETGEGEYANVTLTPGRRHRLRLINTSVENHFQVSLVNHTMCIIAADMVPVNAMTVDSLFLGVGQRYDVVIEANRTPGNYWFNVTFGGGLLCGGSRNPYPAAIFHYAGAPGGPPTDEGKAPVDHNCLDLPNLKPVVARDVPLSGFAKRADNTLDVTLDTTGTPLFVWKVNGSAINIDWGRAVVDYVLTQNTSFPPGYNIVEVNGADQWSYWLIENDPGAPFTLPHPMHLHGHDFYVLGRSPDESPASNERHVFDPARDAGLLSGANPVRRDVSMLPAFGWVVLSFRADNPGAWLFHCHIAWHVSGGLGVVYLERADDLRGAVSDADADDLDRLCADWRRYWPTNPYPKSDSGLKHRWVEEGEWLVKA

SEQ ID NO: 4 - protein, 520 aa, Polyporus pinsitus; identical to SEQ ID NO: 1

SEQ ID NO: 5 - protein, 343 aa, Streptomyces coelicolor
MDRRGFNRRVLLGGAAAATSLSIAPEVAGAAPAAKGITARTAPAGGEVRHLKMYAEKLADGQMGYGFEKGKASVPGPLIEVNEGDTLHIEFTNTMDVRASLHVHGLDYEISSDGTAMNKSDVEPGGTRTYTWRTHKPGRRDDGTWRPGSAGYWHYHDHVVGTEHGTGGIRNGLYGPVIVRRKGDVLPDATHTIVFNDMTINNRKPHTGPDFEATVGDRVEIVMITHGEYYHTFHMHGHRWADNRTGILTGPDDPSRVIDNKITGPADSFGFQIIAGEGVGAGAWMYHCHVQSHSDMGMVGLFLVKKPDGTIPGYEPHEHGGATAKSGESGEPTGGAAAHEHEH

SEQ ID NO: 6 - protein, 555 aa, Aspergillus oryzae
MRGYEFLSVLPLVAASWALPGSTPASVGRRQLPKNPTGVKTLTTANNVTIRYKEPGAEGVCETTPGVKSYSGYVDTSPESHTFFWFFEARHNPETAPITLWLNGGPGSDSLIGLFEELGPCHVNSTFDDYINPHSWNEVSNLLFLSQPLGVGFSYSDTVDGSINPVTGVVENSSFAGVQGRYPTIDATLIDTTNLAAEAAWEILQGFLSGLPSLDSRVQSKDFSLWTESYGGHYGPAFFNHFYEQNERIANGSVNGVQLNFNSLGIINGIIDEAIQAPYYPEFAVNNTYGIKAVNETVYNYMKFANQMPNGCQDLISTCKQTNRTALADYALCAEATNMCRDNVEGPYYAFAGRGVYDIRHPYDDPTPPSYYNKFLAKDSVMDAIGVNINYTQSNNDVYYAFQQTGDFVWPNFIEDLEEILALPVRVSLIYGDADYICNWFGGQAVSLAANYSQAAQFRSAGYTPLKVNGVEYGETREYGNFSFTRVYEAGHEVPYYQPIASLQLFNRTIFGWDIAEGQKKIWPSYKTNGTATATHTQSSVPLPTATSMSSVGMA

SEQ ID NO: 7 - protein, 542 aa, Aspegillus oryzae
MRVLPATLLVGAASAAVPPLQQVLGRPEEGMSFSKPLHAFQEQLKTLSEDARKLWDEVANYFPDSMDHSPIFSLPKKHTRRPDSHWDHIVRGSDVQKIWVNNADGEKEREIDGKLEAYDLRIKKADPSALGIDPNVKQYTGYLDDNGNDKHLFYWFFESRNDPKNDPVVLWLNGGPGCSSLTGLFMELGPSSIDENIKPVYNDFSWNSNASVIFLDQPVNVGYSYSGSAVSDTVAAGKDVYALLSLFFKQFPEYAEQDFHIAGESYAGHYIPVFASEILAHKNRNINLKSVLIGNGLTDGLTQYGYYRPMGCGEGGYKAVLDEATCESMDNALPRCRSMIESCYNSESAWVCVPASIYCNNALIGPYQRTGQNVYDVRSKCEDESNLCYKGMGYVSEYLNKAEVREAVGAEVGGYDSCNFDINRNFLFHGDWMKPYHRLVPGLLEQIPVLIYAGDADYICNWLGNKAWTEALEWPGQKEYASAELEDLKIEQNEHTGKKIGQVKSHGNFTFMRLYGGGHMVPMDQPEASLEFFNRWLGGEWF

(19) United States
(12) Patent Application Publication
(10) Pub. No.: US 2009/0226570 A1
(43) Pub. Date: Sep. 10, 2009

(54) DETOXIFICATION OF FEED PRODUCTS

(75) Inventors: Anders Viksoe-Nielsen, Slangerup (DK); Birthe Hauerbach Soerensen, Frederiksberg (DK)

Correspondence Address: NOVOZYMES NORTH AMERICA, INC., 500 FIFTH AVENUE, SUITE 1600, NEW YORK, NY, 10110, US

(73) Assignee: Novozymes A/S, Bagsvaerd (DK)

(21) Appl. No.: 12/398,284

(22) Filed: Mar. 5, 2009

Related U.S. Application Data
(60) Provisional application No. 61/034,176, filed on Mar. 6, 2008.

(30) Foreign Application Priority Data
Mar. 5, 2008 (EP) 08152315.1

(51) Int. Cl. A23K 1/00

(52) U.S. Cl. 426/53

(57) ABSTRACT

The present invention relates to a method for detoxification of feed products contaminated by the mycotoxin aflatoxin.

### CROSS-REFERENCE TO RELATED APPLICATIONS

This application claims priority or the benefit under 35 U.S.C. 119 of European application no. 08152315.1 filed Mar. 5, 2008 and U.S. provisional application No. 61/034,176 filed Mar. 6, 2008, the contents of which are fully incorporated herein by reference.

### CROSS-REFERENCE TO SEQUENCE LISTING

This application contains a Sequence Listing in computer readable form. The computer readable form is incorporated herein by reference.

### FIELD OF THE INVENTION

The present invention relates to a method for detoxification of feed products contaminated by the mycotoxin aflatoxin.

### BACKGROUND OF THE INVENTION

Aflatoxins are naturally occurring mycotoxins that are produced by many species of Aspergillus, most notably Aspergillus flavus and Aspergillus parasiticus. Aflatoxins are toxic and carcinogenic.

Aflatoxin producing members of Aspergillus are common and widespread in nature. They can colonize and contaminate grain before harvest or during storage. Host crops are particularly susceptible to infection by Aspergillus following prolonged exposure to a high humidity environment or damage from stressful conditions such as drought, a condition which lowers the barrier to entry.

Crops which are frequently affected include cereals, such as maize, sorghum, millet, rice and wheat, and oilseeds, such as rape, peanut, soybean, sunflower and cotton.

When cereal grain is used in ethanol production and the starch is consumed the aflatoxin is concentrated in the fermentation by-products, e.g., in the distillers' dried grain which is used as a feed product, and aflatoxin in the fermentation by-products may be increased three-fold relative to the cereal grain. Thus, distillers' grains contaminated with aflatoxins can pose risks to the safety of animals consuming these products and with the widespread use of distiller's grains in dairy cattle feed there is also a potential human safety concern due to aflatoxin residues in the milk.

Inactivation of aflatoxin by the use of microorganisms is disclosed in WO 2006/053357. Enzymatic inactivation of other mycotoxins is disclosed in WO 96/12414. There is a need for further methods of detoxification of animal feed products, e.g., such as fermentation by-products, including distillers' wet and dried grain, contaminated by the mycotoxin aflatoxin.

### SUMMARY OF THE INVENTION

In a first aspect the invention provides a process for producing a feed product from a vegetable material, said process comprising treating said vegetable material with an enzyme that degrades aflatoxin, to produce a feed product having a reduced level of aflatoxin.

In a second aspect the invention provides a process for degrading aflatoxin in a vegetable material which process comprises treating said vegetable material with an enzyme.

In a third aspect the invention provides a use of an enzyme for degrading aflatoxin.

The enzyme is preferably selected from the group consisting of laccase, cutinase, and carboxypeptidase.

### DETAILED DESCRIPTION OF THE INVENTION

### Aflatoxin

In the context of this invention the term “aflatoxin” comprises any type of aflatoxin. The term “aflatoxin” also comprises any derivative of aflatoxin which is susceptible for modification by an enzyme, e.g., a laccase, a cutinase or a carboxypeptidase.

At least 13 different types of aflatoxin are produced in nature. Aflatoxin B1, which is considered the most toxic, and B2 are produced by both Aspergillus flavus and Aspergillus parasiticus. Aflatoxin G1 and G2 are produced exclusively by A. parasiticus.

Aflatoxins M1 and M2 were originally discovered in the milk of cows which fed on moldy grain. These compounds are products of a conversion process in the animal's liver. However, aflatoxin M1 is also present in the fermentation broth of Aspergillus parasiticus.

While the presence of Aspergillus in feed products does not always indicate harmful levels of aflatoxin are also present, it does imply a significant risk in consumption of that product.

### Vegetable Material

The vegetable material may comprise cereal(s), e.g., one or more of corn, wheat, barley, rye, rice, sorghum and millet, legumes, e.g., one or more of soybean, pea, and peanut, oilseeds, e.g., rape, soybean, sunflower and cotton. The vegetable material may be milled, e.g., wet or dry milled grain, including milling fractions comprising gluten, protein, starch, bran and/or oil.

The vegetable material may be a vegetable material which apart from an unwanted level of aflatoxin is suitable for production of an animal feed product. The vegetable material can also be a vegetable material suspected of comprising an unwanted level of aflatoxin, and/or a vegetable material having an unknown level of aflatoxin, including vegetable material not comprising a detectable level of aflatoxin.

The process of the invention may be combined with any process in which a product suitable as an animal feed product is produced, either as the main product or as a byproduct. Thus the vegetable material of the invention may be the mash of a process for producing a fermentation product. Preferably said fermentation product is an ethanol product, e.g., beer, potable ethanol, fuel ethanol and/or industrial ethanol. The process of the invention may be performed prior to, during or after the fermentation step with the purpose of degrading aflatoxin present in the vegetable material comprised in the mash to produce a product, e.g., the spend grains or the destillers' vet or dried grain with a reduced amount of aflatoxin. Similarly, the vegetable material of the invention may be the grain in a steeping step in a wet milling process, in which process also a product suitable as an animal feed product is produced.

The vegetable material may be a material which apart from an unwanted or unknown level of aflatoxin is suitable for consumption by an animal, i.e., an animal feed product according to the definition below.

### Animal Feed Products

The term “animal” includes all animals, including human beings. Examples of animals are cattle, (including but not limited to cows and calves); mono-gastric animals, e.g., pigs or swine (including, but not limited to, piglets, growing pigs, and sows); poultry such as turkeys and chicken (including but not limited to broiler chicks, layers); and fish (including but not limited to salmon).

The term “feed” or “feed product” means any compound, preparation, mixture, or composition suitable for, or intended for intake by an animal.

The feed product may be a product which apart from an unwanted level of aflatoxin is suitable for consumption by an animal. The feed product can also be a product suspected of comprising an unwanted level of aflatoxin, and/or a product having an unknown level of aflatoxin, including products not comprising a detectable level of aflatoxin.

Preferably the feed product comprises cereal(s), e.g., one or more of corn, wheat, barley, rye, rice, sorghum and millet, legume(s), e.g., one or more of soybean, pea, and peanut, oilseed(s), e.g., rape, soybean, sunflower and cotton. The feed product may be milled, e.g., wet or dry milled grain, including milling fractions comprising gluten, protein, starch, bran and/or oil.

### Laccases

In the context of this invention the term “laccases” include enzymes comprised by the enzyme classification E.C. 1.10.3.2. Preferred are the below mentioned enzymes as well as enzymes with homologous sequence, especially recombinant and/or substantially purified enzymes.

The laccases may be derived from any sources, preferably from a microorganism, such as a fungus or a bacterium. Preferably, the laccase employed is derived from a strain of Polyporus sp., in particular a strain of Polyporus pinisitus or Polyporus versicolor, or a strain of Myceliophthera sp., e.g., M. thermophila or a strain of Rhizoctonia sp., in particular a strain of Rhizoctonia praticola or Rhizoctonia solani, or a strain of a Rhus sp., in particular Rhus vernicifera.

In specific embodiments of the invention the oxidoreductase is the Polyporus pinisitus laccase (also called Trametes villosa laccase) described in WO 96/00290, the Myceliophthora thermophila laccase described in WO 95/33836, or a laccase having an amino acid sequence homologous to any of these sequences.

Further, the laccase may be a Scytalidium sp. laccase, such as the S. thermophilium laccase described in WO 95/33837 or a Pyricularia sp. laccase, such as the Pyricularia oryzae laccase which can be purchased from SIGMA under the trade name SIGMA no. L5510, or a Coprinus sp. laccase, such as a C. cinereus laccase, especially a C. cinereus IFO 30116 laccase, or a Rhizoctonia sp. laccase, such as a R. solani laccase, especially the neutral R. solani laccase described WO 95/07988.

In preferred embodiments the laccase is a laccase from Myceliophthora thermophila (MtL) having the amino acid sequence deposited as GENESEQP: AAR88500 and shown herein as SEQ ID NO: 3, a laccase from Polyporus pinsitus (PpL) having the amino acid sequence deposited as UNIPROT: Q99044 and shown herein as SEQ ID NO: 4, a laccase from Streptomyces coelicolor ScL having the amino acid sequence deposited as SWISSPROT: Q9XAL8 and shown herein as SEQ ID NO: 5, or a laccase having an amino acid sequence homologous to any of these sequences.

The laccase must be present in the medium to be detoxified in effective amounts. Preferably the laccase is present in concentrations of 0.01-100 mg enzyme protein per kg dry matter, preferably 0.1-10 mg enzyme protein per kg dry matter, or more preferably 1-5 mg enzyme protein per kg dry matter.

### The Mediator

In an embodiment wherein a laccase is applied a mediator acting as electron may be used together with the laccase. The mediator should be present in the medium to be detoxified in effective amounts.

Various mediators are known; see, e.g., WO 94/12620, WO 94/12621, WO 95/01626, WO 96/00179 and WO 99/23887. Mediators therein are hereby incorporated by reference.

Preferred for the invention is a mediator selected from methylsyringate (MES), phenothiazine-10-propionicacid (PPT), n-(4-cyanophenyl)acetohydroxamic acid (NCPA), acetosyringone, syringaldehyde, p-coumaric acid, ‘2,2-azinobis(3-ethylbenzthiazoline-6-sulfonate), 1-hydroxybenzotriazole, 2,4-pentanedione, and phenothiazine.

Said mediators are commercially available or can be made by methods known to the art.

### Cutinases

In the context of this invention the term “cutinases” include enzymes comprised by the enzyme classification E.C.3.1.1.74. Preferred are the below mentioned enzymes as well as enzymes with homologous sequence, especially recombinant and/or substantially purified enzymes.

The cutinase may be derived from a microorganism, preferably from a fungus or a bacterium. Particularly, the cutinase may be derived from a strain of Humicola, particularly H. insolens, more particularly H. insolens strain DSM1800 (U.S. Pat. No. 5,827,719) or from a strain of Fusarium, e.g., F. roseum culmorum, or particularly F. solani f.sp. pisi (WO 90/09446; WO 94/14964, WO 94/03578). The fungal cutinase may also be derived from a strain of Rhizoctonia, e.g., R. solani, or a strain of Alternaria, e.g., A. brassicicola (WO 94/03578).

Preferred are the cutinases shown in SEQ ID NO: 1; the Humicola insolens cutinase (corresponding to the mature part of SEQ ID NO: 2 of U.S. Pat. No. 5,827,719, and of SEQ ID NO:1 of WO 01/92502), and in SEQ ID NO: 2; the Fusarium solani f.sp. pisi according to FIG. 1D of WO 94/14964, as well as a laccase having an amino acid sequence homologous to any of these sequences.

The cutinase may also be a variant of a parent cutinase such as those described in WO 00/34450, or WO 01/92502, all of which are hereby incorporated by reference. The cutinase may be the variant of the Humicola insolens cutinase comprising the substitutions E6Q, G8D, A14P, N15D, E47K, S48E, R51P, A88H, A91H, A130V, E179Q and R189V, which is disclosed at p. 24, line 11 of WO 2001/092502 and used in example 1 herein.

The cutinase must be present in the medium to be detoxified in effective amounts. Preferably the cutinase is present in concentrations of 0.01-100 mg enzyme protein per kg dry matter, preferably 0.1-10 mg enzyme protein per kg dry matter, or more preferably 1-5 mg enzyme protein per kg dry matter.

### Carboxypeptidases

In the context of this invention the term the term “carboxypeptidase” refers to an enzyme that cleaves the C-terminal peptide bond of a peptide or polypeptide chain. The group comprises but is not limited to the enzymes assigned to enzyme subclass EC 3.4.16, Serine-type carboxypeptidases.

Preferred are the below mentioned enzymes, especially recombinant and/or substantially purified enzymes. The carboxypeptidase may be derived from any sources, preferably from a microorganism, such as a fungus or a bacterium. In preferred embodiments the carboxypeptidase is derived from Aspergillus oryzae, preferably such as the carboxypeptidases shown in SEQ ID NO: 5 and in SEQ ID NO: 6.

The carboxypeptidase must be present in the medium to be detoxified in effective amounts. Preferably the carboxypeptidase is present in concentrations of 0.01-100 mg enzyme protein per kg dry matter, preferably 0.1-10 mg enzyme protein per kg dry matter, or more preferably 1-5 mg enzyme protein per kg dry matter.

### The Medium

In an embodiment the enzyme is degrading the aflatoxin in a medium comprising the feed product. The medium is preferably aqueous and may be a liquid, a paste or a slurry. To form a suitable medium water may be added to the feed product. The enzyme and if relevant the mediator, may be comprised, either separately or together, in solid or liquid formulations suitable for application to said medium.

The detoxifixation efficiency of the invention depends on, e.g., availability of oxygen, pH, temperature and buffer of the medium. For example, the treatment may take place at a pH-value at which the relative activity of the actual enzyme is at least 50%, at least 60%, at least 70%, at least 80%, or even at least 90%. Likewise, for example, the treatment may take place at a temperature at which the relative activity of the actual enzyme is at least 50%, at least 60%, at least 70%, at least 80%, or even at least 90%. The relative activity is calculated relative to the activity at the pH value where the highest activity is observed.

### Oxygen in the Medium

When a laccase is applied the source of oxygen required may be oxygen from the atmosphere or an oxygen precursor for in situ production of oxygen. Oxygen from the atmosphere will usually be present in sufficient quantity. If more O₂ is needed, additional oxygen may be added, e.g., as pressurized atmospheric air or as pure pressurized oxygen.

### pH in the Medium

Depending, inter alia, on the characteristics of the enzyme employed, the pH in the medium employed should normally be in the range of 5-11, preferably in the range 6-10, e.g., 6.5-8.5.

### Temperature in the Medium

Preferably a reaction temperature is applied which is close to the optimum temperature for the enzyme. In numerous embodiments of the invention, temperatures in the range of 10-65° C., more preferably 30-50° C. should be employed.

### Treatment Duration

The duration of treatment depends, inter alia, on the treatment type, the type of item to be treated, the properties of the medium, e.g., temperature and pH and the type and amounts of enzyme employed.

The enzymatic reaction is continued until the desired result is achieved, following which it may or may not be stopped by inactivating the enzyme, e.g., by a heat-treatment step.

For detoxification purposes treatment times in the range of 1 minute to 1 week may be employed. In many cases a treatment time in the range of 6 to 48 hours will be suitable.

By the process of the invention the content of aflatoxin in the feed product is preferably reduced to less than 90%, less than 80%, less than 70%, less than 60%, less than 50%, less than 40%, less than 30%, less than 20%, less than 15%, less than 10%, or even less than 5%, such as less than 4, 3, 2 or even 1% relative to the level prior to the process.

### Identity

The relatedness between two amino acid sequences or between two nucleotide sequences is described by the parameter “identity”.

For purposes of the present invention, the degree of identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends in Genetics 16: 276-277), preferably version 3.0.0 or later. The optional parameters used are gap open penalty of 10, gap extension penalty of 0.5, and the EBLOSUM62 (EMBOSS version of BLOSUM62) substitution matrix. The output of Needle labeled “longest identity”

(obtained using the—nobrief option) is used as the percent identity and is calculated as follows:

(Identical Residues×100)/(Length of Alignment−Total Number of Gaps in Alignment)

For purposes of the present invention, the degree of identity between two deoxyribonucleotide sequences is determined using the Needleman-Wunsch algorithm (Needleman and Wunsch, 1970, supra) as implemented in the Needle program of the EMBOSS package (EMBOSS: The European Molecular Biology Open Software Suite, Rice et al., 2000, supra), preferably version 3.0.0 or later. The optional parameters used are gap open penalty of 10, gap extension penalty of 0.5, and the EDNAFULL (EMBOSS version of NCBI NUC4.4) substitution matrix. The output of Needle labeled “longest identity” (obtained using the—nobrief option) is used as the percent identity and is calculated as follows:

(Identical Deoxyribonucleotides×100)/(Length of Alignment−Total Number of Gaps in Alignment)

### Homologous Sequence

The term “homologous sequence” is defined as a predicted protein that gives an E value (or expectancy score) of less than 0.001 in a tfasty search (Pearson, W. R., 1999, in Bioinformatics Methods and Protocols, S. Misener and S. A. Krawetz, ed., pp. 185-219) with a specified sequence.

The term “homologous sequence” may also be defined as a sequence that has a degree of identity at least 75%, at least 80%, at least 85%, at least 90%, at least 95%, at least 97%, at least 98%, at least 99%, or even 100%, to a specified sequence.

### EXAMPLES

### Materials and Methods

### Enzymes

A cutinase which is a variant of the Humicola insolens cutinase shown in SEQ ID NO: 1 with the substitutions E6Q, G8D, A14P, N15D, E47K, S48E, R51P, A88H, A91H, A130V, E179Q and R189V.

A laccase from Myceliophthora thermophila (MtL) having the amino acid sequence shown herein as SEQ ID NO: 3.

A laccase from Streptomyces coelicolor (ScL) having the amino acid sequence shown herein as SEQ ID NO: 4.

A laccase from Polyporus pinsitus (PpL) having the amino acid sequence shown herein as SEQ ID NO: 5.

A carboxypeptidase from Aspergillus oryzae (CPY) having the amino acid sequence shown herein as SEQ ID NO: 7.

### Mediators

### Methylsyringate (MeS)

Phenothiazine-10-propionicacid (PPT)
Assay: Reactions were performed in 600 microL volumes in eppendorf tubes comprising aflatoxin 30 microM, sodium acetate 100 mM and enzyme 0.1 mg EP/mL. In reactions involving laccase 0.2 mM mediator was included. In control reactions the enzyme volume was substituted with an equivalent amount of H₂O. The reactions were incubate 24 hours at 37° C. before being terminated by adding 600 microL of a 100 microM acetonitrile stop solution. Reactions were stored at −20° C. until chromatographic analysis.
Chromatographic analysis: Samples were centrifugated and the supernatant analysed for aflatoxin by HPLC-DAD as described by Smedsgaard (J. Chromatogr. A, 1997, 760: 264-270). The DAD scanned from 200-600 nm. Separation was done on a Phenomenex (Torrance, Calif.) Luna C18(2) 10×2 mm ID, 3 micrometer, column 2, using a linear gradient moving form 5% to 100% acetonitrile in 20 min. Residual aflatoxin was calculated relative to the control.

### Example 1

TABLE 1
Residual aflatoxin after 24 hours incubation with 3 laccases
(MtL, PpL or ScL) and MeS as mediator at pH 4.5 or pH 7.0

| Enzyme | pH | Residual aflatoxin (%) |
|---|---|---|
| Control | 4.5 | 100 |
| MtL + MeS | 4.5 | 48 |
| ScL + MeS | 4.5 | 39 |
| MtL | 4.5 | 63 |
| Control | 7.0 | 100 |
| MtL + MeS | 7.0 | 8 |
| PbL + MeS | 7.0 | 45 |
| ScL + MeS | 7.0 | 0 |
| MtL | 7.0 | 70 |

### Example 2

TABLE 2
Residual aflatoxin after 24 hours incubation
with a cutinase at pH 4.5 or pH 7.0

| Enzyme | pH | Residual aflatoxin (%) |
|---|---|---|
| Control | 4.5 | 100 |
| Cutinase | 4.5 | 49 |
| Control | 7.0 | 100 |
| Cutinase | 7.0 | 62 |

### Example 3

TABLE 3
Residual aflatoxin after 24 hours incubation
with a carboxypeptidase at pH 4.5.

| Enzyme | Residual aflatoxin (%) |
|---|---|
| Control | 100 |
| carboxypeptidase | 66 |

1. A process for producing a feed product, said process comprising treating a vegetable material with an enzyme that degrades aflatoxin, to produce a feed product having a reduced level of aflatoxin.

2. A process for degrading aflatoxin in a vegetable material which process comprises treating said vegetable material with an enzyme.

3. The process of claim 1, wherein the vegetable material is a mash of a fermentation process or the grain in a wet milling process.

4. The process of claim 1, wherein the vegetable material is a feed product.

5. The process of claim 1, wherein the enzyme is a laccase.

6. The process of claim 1, further comprising treating the vegetable material with a mediator.

7. The process of claim 6, wherein the mediator is methylsyringate or phenothiazine-10-propionicacid.

8. The process of claim 1, wherein the enzyme is a cutinase.

9. The process of claim 8, wherein the cutinase is a cutinase having the sequence shown in SEQ ID NO: 1 or a homologous sequence.

10. The process of claim 8, wherein the cutinase is a variant of the cutinase shown in SEQ ID NO:1 comprising one or more, including all of the substitutions G8D, N15D, S48E, A88H, N91H, A130V and R189V.

11. The process of claim 1, wherein the enzyme a carboxypeptidase.

12. The process of claim 11, wherein the carboxypeptidase is a carboxypeptidase having the sequence shown in SEQ ID NO: 5, in SEQ ID NO: 6 or a homologous sequence.

13. The process of claim 1, wherein the feed product comprises one or more components selected from corn, wheat, barley, rye, rice, sorghum and millet.

14. The process of claim 1, wherein the feed product comprises brewers spent grain, distillers' spent grain, distillers' wet grain, and/or distillers' dried grain.
